(19) United States
(12) Patent Application Publication
(10) Pub. No.: US 2011/0085729 A1
(43) Pub. Date: Apr. 14, 2011

(54) DE-NOISING METHOD AND RELATED APPARATUS FOR IMAGE SENSOR

(76) Inventors: Miaohong Shi, Grand Cayman (KY); Amit Mittra, Grand Cayman (KY)

(21) Appl. No.: 12/577,210

(22) Filed: Oct. 12, 2009

(51) Int. Cl. G06K 9/40; H04N 5/217

(52) U.S. Cl. 382/167; 382/260; 348/241; 348/273; 348/E05.078

(57) ABSTRACT

A de-noising method includes: comparing a pixel value of a target pixel with pixel values of a plurality of nearby pixels, wherein each of the target pixel and the nearby pixels corresponds to a specific color component; for each nearby pixel of the nearby pixels, checking if a difference between the pixel value of the target pixel and a pixel value of a nearby pixel of the nearby pixels is smaller than a specific noise threshold value, and when the difference between the pixel value of the target pixel and the pixel value of the nearby pixel is smaller than the specific noise threshold value, setting the nearby pixel as a similar nearby pixel; and updating the pixel value of the target pixel according to the pixel value of the target pixel and a pixel value of each similar nearby pixel.

### BACKGROUND OF THE INVENTION

1. Field of the Invention

The present invention relates to image processing, and more particularly, to a de-noising method and related apparatus utilizing a specific noise threshold value for an image sensor.

2. Description of the Prior Art

In an imaging system, three components of color information must be captured simultaneously to precisely present an image. To create an analogous digital imaging system that simultaneously captures all three components of the color information requires three individual imaging detectors. This would be prohibitive due to the high cost and would also cause the packaging to be very complex. To keep the size and cost of a digital video imaging system to a minimum, an image sensor array of the system must also be kept to a small size. Therefore, the number of color samples must be kept low. An alternative approach is to have each detector of the imaging system gather data for a single color to create a sparse color image. To achieve this, the imaging systems typically use a mosaic filter generally called a color filter array (CFA), and acquire a scene image by sampling one of the three different color components to obtain an array that stores only one color component per pixel. The imaging system gets raw sensory data having less color samples per pixel because it ignores the other two color components for each pixel. Since each filter of the color filter array covers a single pixel and only allows a color in a specific spectral band to pass, before the scene image is further processed or displayed, the missing colors of each image pixel must be reconstructed so that each image pixel contains all three needed color components.

No images are absolutely perfect no matter how good the camera, since images are interfered with by the presence of noise. The principal sources of noise in digital images arise during image acquisition, digitization, and/or transmission. The performance of imaging sensors is affected by a variety of factors, such as environmental conditions during image acquisition, and by the quality of the sensing elements themselves. For instance, when acquiring images with a Charge-Coupled Device (CCD) sensor or a CMOS image sensor, luminosity and sensor temperature are major factors affecting the amount of noise in the generated images.

Filtering a digital image is one necessary stage in image processing and is used for reducing noise when protecting image details. For example, any noise in images will result in serious errors due to many applications being based on operands drawn out from applications for calculating images. Therefore, methods for reducing noise are desired to not only improve the visual quality, but also to improve the performance of subsequent processing tasks such as coding, analysis cutting, identification, or interpretation.

### SUMMARY OF THE INVENTION

It is therefore one of the objectives of the present invention to provide a de-noising method and related apparatus utilizing a specific noise threshold value for an image sensor, to remove as much noise as possible while blurring the edges and other image details as little as possible.

According to one embodiment of the present invention, a de-noising method for an image sensor is disclosed, wherein the image sensor includes a specific color filter array and a pixel array. The pixel array includes a plurality of pixels. Each pixel corresponds to one color filter, and thus corresponds to one of a plurality of color components. The de-noising method comprises: comparing a pixel value of a target pixel with pixel values of a plurality of nearby pixels, wherein each of the target pixel and the nearby pixels corresponds to a specific color component; for each nearby pixel of the nearby pixels, utilizing a checking circuit to check if a difference between the pixel value of the target pixel and a pixel value of a nearby pixel of the nearby pixels is smaller than a specific noise threshold value, and when a difference between the pixel value of the target pixel and a pixel value of a nearby pixel of the nearby pixels is smaller than a specific noise threshold value, setting the nearby pixel as a similar nearby pixel; and updating the pixel value of the target pixel according to the pixel value of the target pixel and a pixel value of each similar nearby pixel.

According to another embodiment of the present invention, a de-noising apparatus for an image sensor is disclosed, wherein the image sensor includes a specific color filter array and a pixel array. The pixel array includes a plurality of pixels. Each pixel corresponds to one color filter, and thus corresponds to one of a plurality of color components. The de-noising apparatus includes a comparing circuit, a checking circuit and a pixel value updating circuit. The comparing circuit is for comparing a pixel value of a target pixel with pixel values of a plurality of nearby pixels, wherein each of the target pixel and the nearby pixels corresponds to a specific color component. For each nearby pixel of the nearby pixels, the checking circuit checks if a difference between the pixel value of the target pixel and a pixel value of a nearby pixel of the nearby pixels is smaller than a specific noise threshold value, and when a difference between the pixel value of the target pixel and a pixel value of a nearby pixel of the nearby pixels is smaller than a specific noise threshold value, the checking circuit sets the nearby pixel as a similar nearby pixel. The pixel value updating circuit is coupled to the checking circuit, and implemented for updating the pixel value of the target pixel according to the pixel value of the target pixel and a pixel value of each similar nearby pixel.

The exemplary embodiments of the present invention provide a de-noising method and related apparatus utilizing a specific noise threshold value for an image sensor while preserving edges and other image details.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a de-noising apparatus according to an exemplary embodiment of the present invention.

FIG. 2A is a diagram illustrating an image sensor according to an exemplary embodiment of the present invention.

FIG. 2B is a diagram illustrating an image sensor according to another exemplary embodiment of the present invention.

FIG. 2C is a diagram illustrating an image sensor according to yet another exemplary embodiment of the present invention.

FIG. 3 is a flowchart illustrating a de-noising method for an image sensor according to an embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

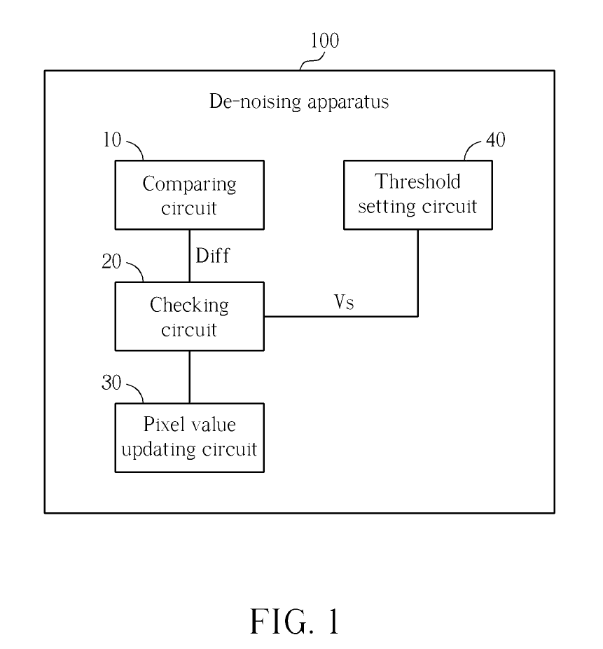

Please refer to FIG. 1. FIG. 1 is a diagram illustrating a de-noising apparatus 100 for an image sensor according to an exemplary embodiment of the present invention. The de-noising apparatus 100 utilizes a specific noise threshold value Vs for the image sensor. The image sensor includes a specific color filter array and a pixel array. Each pixel corresponds to one color filter, and thus corresponds to one of a plurality of color components. For the purpose of explanatory convenience in the following description, it is assumed herein that the specific color filter array is a Bayer color filter array in this embodiment; however, it is to be noted that the scope of the present invention is not limited thereto.

The de-noising apparatus 100 includes a comparing circuit 10, a checking circuit 20, a pixel value updating circuit 30 and a threshold setting circuit 40. The comparing circuit 10 is used for comparing a pixel value of a target pixel Pt with pixel values of a plurality of nearby pixels in the pixel array, wherein each of the target pixel Pt and the nearby pixels corresponds to a specific color component. That is, the target pixel Pt and the selected nearby pixels which are compared with the target pixel Pt have the same color component. The difference Diff between a pixel value of the target pixel Pt and a pixel value of each of the selected nearby pixel is calculated by the comparing circuit 10 and then passed to the following checking circuit 20 coupled to the comparing circuit 10.

For each nearby pixel Pn of the selected nearby pixels, the checking circuit 20 is implemented for checking if the difference Diff between the pixel value of the target pixel Pt and a pixel value of the nearby pixel Pn is smaller than the specific noise threshold value Vs. In this exemplary embodiment, when the difference Diff between the pixel value of the target pixel Pt and the pixel value of the nearby pixel Pn is smaller than the specific noise threshold value Vs, the checking circuit 20 sets the nearby pixel Pn as a similar nearby pixel.

The pixel value updating circuit 30 is coupled to the checking circuit 20, and implemented for updating the pixel value of the target pixel Pt according to the pixel value of the target pixel Pt and a pixel value of each similar nearby pixel identified by the checking circuit 20. The threshold setting circuit 40, coupled to the checking circuit 20, is for setting the specific noise threshold value Vs according to the target pixel Pt. The details directed to setting the specific noise threshold value Vs and updating a pixel value of the target pixel Pt will be illustrated later.

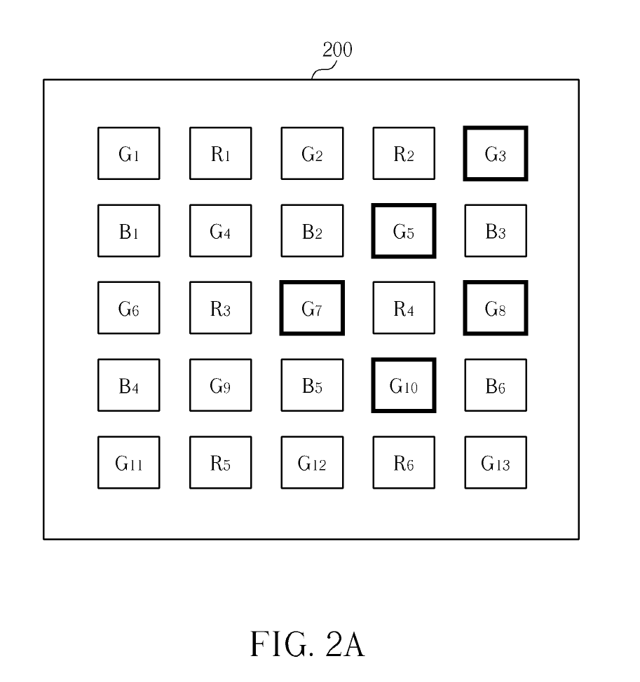

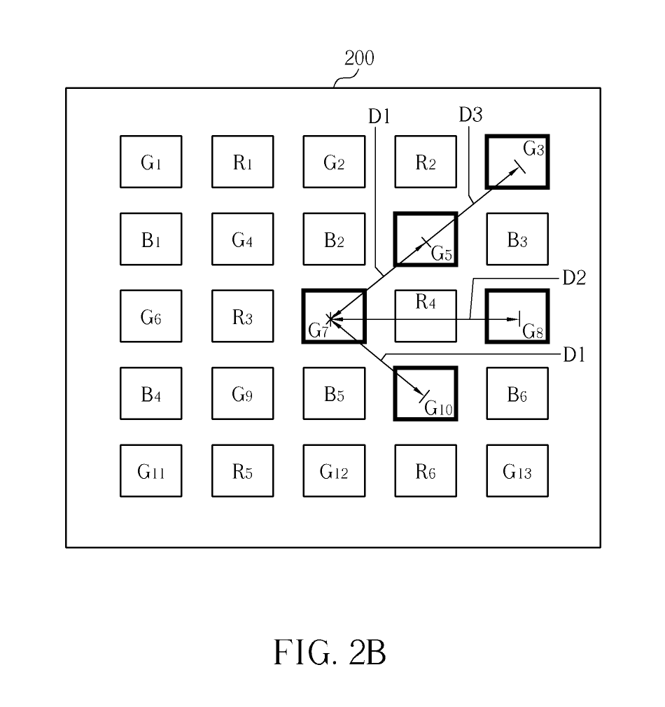

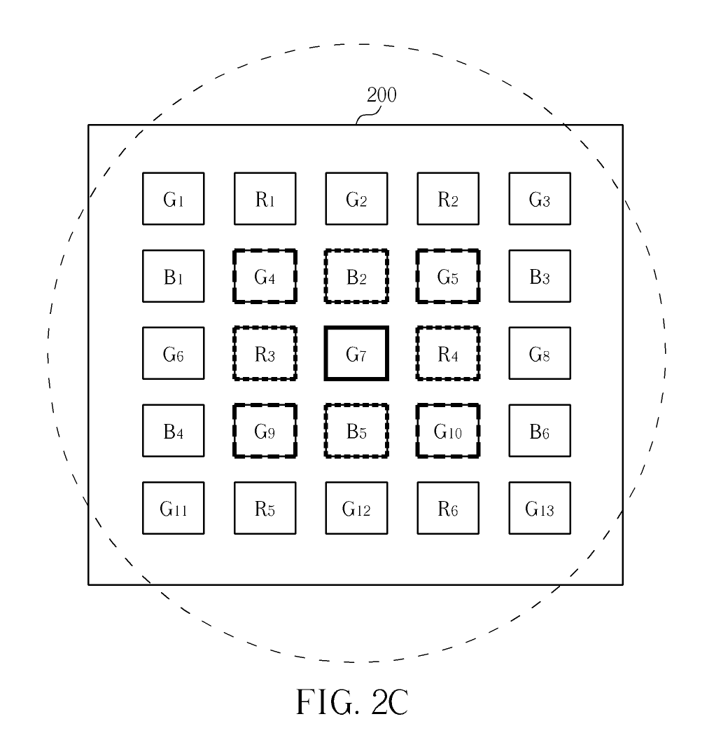

Please refer to FIG. 1 in conjunction with FIG. 2A. FIG. 2A is a diagram illustrating an image sensor 200 according to an exemplary embodiment of the present invention. As shown in FIG. 2A, the image sensor 200 includes pixels G₁-G₁₃ corresponding to a green color, pixels R₁-R₆ corresponding to a red color, and pixels B₁-B₆ corresponding to a blue color. Since noise is typically more visible in the red and blue pixels than in the green pixel, the threshold setting circuit 40 sets the specific noise threshold value Vs according to the specific color component of the target pixel Pt. When the target pixel Pt is a green pixel (e.g., pixel G₁) in the image sensor 200, the threshold setting circuit 40 sets the specific noise threshold value Vs by a first color value C1; when the target pixel Pt is a red pixel (e.g., pixel R₁) in the image sensor 200, the threshold setting circuit 40 sets the specific noise threshold value Vs by a second color value C2 different from the first color value C1; and when the target pixel Pt is a blue pixel (e.g., pixel B₁) in the image sensor 200, the threshold setting circuit 40 sets the specific noise threshold value Vs by a third color value C3 different from the first color value C1.

Taking the pixel G₇ corresponding to the green color as the target pixel Pt for example, the comparing circuit 10 compares a pixel value of the target pixel G₇ with pixel values of a plurality of nearby pixels G₁, G₂, G₃, G₄, G₅, G₆, G₈, G₉, G₁₀, G₁₁, G₁₂, G₁₃ in the image sensor 200. It should be noted that the above exemplary selection of the nearby pixels is for illustrative purposes only. In other words, the rule of selecting the nearby pixels of the target pixel can be adjusted, depending upon design requirements.

The checking circuit 20 checks if a first difference Diff_1 between the pixel value of the target pixel G₇ and a pixel value of a nearby pixel G₁ of the nearby pixels is smaller than the first color value C1, and if it is determined that the first difference Diff_1 is smaller than the first color value C1, the checking circuit 20 sets the nearby pixel G₁ as a similar nearby pixel. The checking circuit 20 keeps checking if a second difference Diff_2 between the pixel value of the target pixel G₇ and a pixel value of another nearby pixel G₂ of the nearby pixels is smaller than the first color value C1, and if it is determined that the second difference Diff_2 is smaller than the first color value C1, the checking circuit 20 sets the nearby pixel G₂ as a similar nearby pixel, and so on. After finishing the above checking operation performed by the checking circuit 20, if the nearby pixels G₃, G₅, G₈, G₁₀ are categorized as similar nearby pixels, the pixel value updating circuit 30 averages the pixel value of the target pixel G₇ with pixel values of the similar nearby pixels G₃, G₅, G₈, G₁₀ to update the pixel value of the target pixel G₇. More specifically, the updated pixel value of the target pixel G₇ can be expressed as follows:

$${Pixel\_G}_{7} = \frac{1}{5} ( {Pixel\_G}_{7} + {Pixel\_G}_{3} + {Pixel\_G}_{5} + {Pixel\_G}_{8} + {Pixel\_G}_{10} ) \qquad ( 1 )$$

In the above equation (1), Pixel_G₇, Pixel_G₃, Pixel_G₅, Pixel_G₈, and Pixel_G₁₀ represent pixel values of the target pixel G₇ and the nearby pixels G₃, G₅, G₈, G₁₀, respectively.

Please refer to FIG. 2B. FIG. 2B is a diagram illustrating an image sensor 200 according to another exemplary embodiment of the present invention. In this embodiment, the pixel value updating circuit 30 can set a weighting factor of each similar nearby pixel according to a distance between the target pixel G₇ and the similar nearby pixels G₃, G₅, G₈, G₁₀ when the pixel value updating circuit 30 averages the pixel value of the target pixel G₇ with pixel values of the similar nearby pixels G₃, G₅, G₈, G₁₀. That is, a weight-averaging operation is performed to derive an updated pixel value for the target pixel G₇. For example, as shown in FIG. 2B, the distances between the target pixel G₇ and the similar nearby pixels G₅, G₁₀ are D1. The weighting factors of the similar nearby pixels G₅, G₁₀ therefore can be set by a first weighting value W1. Similarly, the distance between the target pixel G₇ and the similar nearby pixel G₈ is D2. The weighting factor of the similar nearby pixel G₈ therefore can be set by a second weighting value W2. And the distance between the target pixel G₇ and the similar nearby pixel G₃ is D3. The weighting factor of the similar nearby pixel G₃ therefore can be set by a third weighting value W3. The updated pixel value of the target pixel G₇ can be expressed as follows:

$${Pixel\_G}_{7} = \frac{1}{1 + 2 W 1 + W 2 + W 3} ( {Pixel\_G}_{7} + W 3 * {Pixel\_G}_{3} + W 1 * {Pixel\_G}_{5} + W 2 * {Pixel\_G}_{8} + W 1 * {Pixel\_G}_{10} ) \qquad ( 2 )$$

In the above equation (2), Pixel_G₇, Pixel_G₃, Pixel_G₅, Pixel_G₈, and Pixel_G₁₀ represent pixel values of the target pixel G₇ and the nearby pixels G₃, G₅, G₈, G₁₀, respectively. However, this embodiment merely serves as an example for illustrating the present invention, and should not be taken as a limitation of the present invention. It should be appreciated by those skilled in the art that the present invention can adopt other averaging methods to derive an updated pixel value set to the target pixel.

Please refer to FIG. 2C. FIG. 2C is a diagram illustrating an image sensor 200 according to yet another exemplary embodiment of the present invention. The dotted circle is an image circle corresponding to a lens. Since corner noise will be enhanced by the lens shading correction gain, noise distribution is usually not uniform throughout the whole image circle. Thus in one example the specific noise threshold value Vs=center noise threshold value * lens shading correction gain. For another specific example, noise is typically more visible in a corner area than in the center area. Therefore, the threshold setting circuit 40 sets the specific noise threshold value Vs according to a location of the target pixel Pt in the image sensor 200. Taking the image sensor 200 as an example, when the pixel G₇ is the target pixel Pt, the threshold setting circuit 40 sets the specific noise threshold value Vs by a first location value L1; when the pixels B₂, B₅, R₃, R₄ are the target pixel Pt, the threshold setting circuit 40 sets the specific noise threshold value Vs by a second location value L2 different from the first location value L1 (L2>L1); when the pixels G₄, G₅, G₉, G₁₀ are the target pixel Pt, the threshold setting circuit 40 sets the specific noise threshold value Vs by a third location value L3 different from the second location value L2 (L3>L2), and so on. In short, when the target pixel is located at a first location in the image sensor 200, the specific noise threshold value is set by a first value; and when the target pixel is located at a second location in the image sensor 200 where the first location is closer to a center location of the image sensor 200 than the second location, the specific noise threshold value is set by a second value different from the first value, where the first value is smaller than the second value. After setting the specific noise threshold value Vs by different location values, other operations of the de-noising apparatus 100 are similar to the afore-mentioned embodiments, and thus further description is omitted here for brevity.

It is worth noticing that, as light intensity decreases, the applied gain of the image sensor 200 will be increased which also enhances noise. Therefore, according to yet another embodiment of the present invention, the threshold setting circuit 40 sets the specific noise threshold value Vs according to an applied gain value corresponding to a light intensity. Taking the image sensor 200 for example, when the light intensity corresponds to a first luminance value, the specific noise threshold value Vs is set by a first light value V1, and when the light intensity corresponds to a second luminance value different from the first luminance value, the specific noise threshold value Vs is set by a second light value V2 different from the first light value V1. In one implementation, the first luminance value is greater than the second luminance value, and the first light value V1 is set smaller than the second light value V2. After setting the specific noise threshold value Vs by different luminance values, other operations of the de-noising apparatus 100 are similar to the afore-mentioned embodiments, and thus further description is omitted here for brevity.

Please note that any alternative designs combining features of the above-mentioned embodiments should also fall within the scope of the present invention. For example, the specific noise threshold value Vs can be first set according to the color component of the target pixel, and then set according to an applied gain value corresponding to a light intensity. Furthermore, please note that the de-noising operation in the above exemplary embodiments is applied to a target pixel with a green color (e.g., pixel G₇); however, the de-noising operation can also be applied to a target pixel with a red color or blue color.

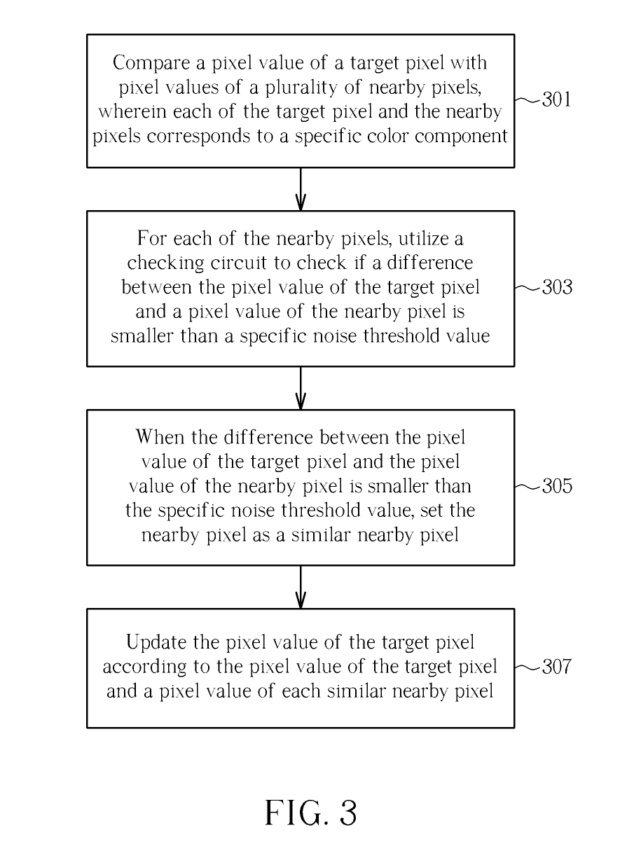

Please refer to FIG. 3. FIG. 3 is a flowchart illustrating a de-noising method 300 for an image sensor according to an embodiment of the present invention. For brevity, the de-noising method is applied in the de-noising apparatus 100 as shown in FIG. 1. Provided the result is substantially the same, the steps are not required to be executed in the exact order shown in FIG. 3. The de-noising method can be briefly summarized by the following steps:

Step 301: Compare a pixel value of a target pixel with pixel values of a plurality of nearby pixels, wherein each of the target pixel and the nearby pixels corresponds to a specific color component;

Step 303: For each of the nearby pixels, utilize a checking circuit to check if a difference between the pixel value of the target pixel and a pixel value of the nearby pixel is smaller than a specific noise threshold value;

Step 305: When the difference between the pixel value of the target pixel and the pixel value of the nearby pixel is smaller than the specific noise threshold value, set the nearby pixel as a similar nearby pixel; and

Step 307: Update the pixel value of the target pixel according to the pixel value of the target pixel and a pixel value of each similar nearby pixel.

Please note that, as those skilled in this art can easily understand the operations of the steps 301-307 of the de-noising method after reading the disclosure of the above-mentioned embodiments directed to the de-noising apparatus, further description is omitted here for brevity.

In summary, the de-noising apparatus 100 can significantly remove noise of the pixels in an image sensor by setting a suitable noise threshold value. The present invention is designed for the image sensor such that the noise is removed at the earliest stage to avoid noise accumulation in the image processing pipeline. The specific noise threshold value can be adaptively adjusted based on noise level and noise distribution, thereby optimizing the de-noising performance.

Those skilled in the art will readily observe that numerous modifications and alterations of the device and method may be made while retaining the teachings of the invention.

What is claimed is:

1. A de-noising method for an image sensor including a specific color filter array and a pixel array, the pixel array including a plurality of pixels each corresponding to one of a plurality of color components, the de-noising method comprising:
comparing a pixel value of a target pixel with pixel values of a plurality of nearby pixels, wherein each of the target pixel and the nearby pixels corresponds to a specific color component;
for each nearby pixel of the nearby pixels:
utilizing a checking circuit to check if the pixel value of the target pixel is similar to a pixel value of the nearby pixel; and
when the pixel value of the target pixel is determined similar to the pixel value of the nearby pixel, setting the nearby pixel as a similar nearby pixel; and
updating the pixel value of the target pixel according to the pixel value of the target pixel and a pixel value of each similar nearby pixel.

2. The de-noising method of claim 1, wherein the pixel value of the target pixel is determined to be similar to the pixel value of the nearby pixel when a difference between the pixel value of the target pixel and the pixel value of the nearby pixel is smaller than a specific noise threshold value.

3. The de-noising method of claim 2, further comprising:
setting the specific noise threshold value according to the specific color component of the target pixel;
wherein when the specific color component of the target pixel is a first color component, the specific noise threshold value is set by a first value; and when the specific color component of the target pixel is a second color component which is different from the first color component, the specific noise threshold value is set by a second value different from the first value.

4. The de-noising method of claim 3, wherein the first color component is either a red color or a blue color, the second color component is a green color, and the second value is smaller than the first value.

5. The de-noising method of claim 2, further comprising:
setting the specific noise threshold value according to a location of the target pixel in the image sensor;
wherein when the target pixel is located at a first location in the image sensor, the specific noise threshold value is set by a first value; and when the target pixel is located at a second location in the image sensor, the specific noise threshold value is set by a second value different from the first value, wherein the second location is different from the first location.

6. The de-noising method of claim 5, wherein the first location is closer to a center location of the image sensor than the second location, and the first value is smaller than the second value.

7. The de-noising method of claim 2, further comprising:
setting the specific noise threshold value according to an applied gain value corresponding to a light intensity;
wherein when the light intensity corresponds to a first luminance value, the specific noise threshold value is set by a first value; and when the light intensity corresponds to a second luminance value different from the first luminance value, the specific noise threshold value is set by a second value different from the first value.

8. The de-noising method of claim 7, wherein the first luminance value is greater than the second luminance value and the first value is smaller than the second value.

9. The de-noising method of claim 2, wherein the step of updating the pixel value of the target pixel comprises:
performing a weight-averaging operation upon the pixel value of the target pixel and the pixel value of each similar nearby pixel to generate an average value; and
updating the pixel value of the target pixel by the average value.

10. The de-noising method of claim 9, wherein the step of updating the pixel value of the target pixel further comprises:
setting a weighting factor of each similar nearby pixel according to a distance between the target pixel and the similar nearby pixel;
wherein when the distance between the target pixel and the similar nearby pixel is equal to a first distance value, the weighting factor is set by a first value; when the distance between the target pixel and the similar nearby pixel is equal to a second distance value different from the first distance value, the weighting factor is set by a second value different from the first value; and when the first distance value is smaller than the second distance value, the first value is set greater than the second value.

11. A de-noising apparatus for an image sensor including a specific color filter array and a pixel array, the pixel array including a plurality of pixels each corresponding to one of a plurality of color components, the de-noising apparatus comprising:
a comparing circuit, for comparing a pixel value of a target pixel with pixel values of a plurality of nearby pixels, wherein each of the target pixel and the nearby pixels corresponds to a specific color component;
a checking circuit, coupled to the comparing circuit, wherein for each nearby pixel of the nearby pixels:
the checking circuit checks if the pixel value of the target pixel is similar to a pixel value of the nearby pixel, and when the pixel value of the target pixel is similar to the pixel value of the nearby pixel, the checking circuit sets the nearby pixel as a similar nearby pixel; and
a pixel value updating circuit, coupled to the checking circuit, for updating the pixel value of the target pixel according to the pixel value of the target pixel and a pixel value of each similar nearby pixel.

12. The de-noising apparatus of claim 11, wherein the pixel value of the target pixel is determined to be similar to the pixel value of the nearby pixel when a difference between the pixel value of the target pixel and the pixel value of the nearby pixel is smaller than a specific noise threshold value.

13. The de-noising apparatus of claim 12, further comprising:
a threshold setting circuit, coupled to the checking circuit, for setting the specific noise threshold value according to the specific color component of the target pixel;
wherein when the specific color component of the target pixel is a first color component, the threshold setting circuit sets the specific noise threshold value by a first value; and when the specific color component of the target pixel is a second color component which is different from the first color component, the threshold setting circuit sets the specific noise threshold value by a second value different from the first value.

14. The de-noising apparatus of claim 13, wherein the first color component is either a red color or a blue color, the second color component is a green color, and the second value is smaller than the first value.

15. The de-noising apparatus of claim 12, further comprising:
a threshold setting circuit, coupled to the checking circuit, for setting the specific noise threshold value according to a location of the target pixel in the image sensor;
wherein when the target pixel is located at a first location in the image sensor, the threshold setting circuit sets the specific noise threshold value by a first value; and when the target pixel is located at a second location in the image sensor, the threshold setting circuit sets the specific noise threshold value by a second value different from the first value, where the second location is different from the first location.

16. The de-noising apparatus of claim 15, wherein the first location is closer to a center location of the image sensor than the second location, and the first value is smaller than the second value.

17. The de-noising apparatus of claim 12, further comprising:
a threshold setting circuit, coupled to the checking circuit, for setting the specific noise threshold value according to an applied gain value corresponding to a light intensity;
wherein when the light intensity corresponds to a first luminance value, the threshold setting circuit sets the specific noise threshold value by a first value; and when the light intensity corresponds to a second luminance value different from the first luminance value, the threshold setting circuit sets the specific noise threshold value by a second value different from the first value.

18. The de-noising apparatus of claim 17, wherein the first luminance value is greater than the second luminance value, and the first value is smaller than the second value.

19. The de-noising apparatus of claim 12, wherein the pixel value updating circuit performs a weight-averaging operation upon the pixel value of the target pixel and the pixel value of each similar nearby pixel to generate an average value, and updates the pixel value of the target pixel by the average value.

20. The de-noising apparatus of claim 19, wherein the pixel value updating circuit further sets a weighting factor of each similar nearby pixel according to a distance between the target pixel and the similar nearby pixel; when the distance between the target pixel and the similar nearby pixel is equal to a first distance value, the pixel value updating circuit sets the weighting factor by a first value; when the distance between the target pixel and the similar nearby pixel is equal to a second distance value different from the first distance value, the pixel value updating circuit sets the weighting factor by a second value different from the first value; and when the first distance value is smaller than the second distance value, the first value is set greater than the second value.
